(19) United States
(12) Patent Application Publication
(10) Pub. No.: US 2025/0238200 A1
(43) Pub. Date: Jul. 24, 2025

(54) Secure Noise Addition in Floating-Point Numbers

(71) Applicant: International Business Machines Corporation, Armonk, NY (US)

(72) Inventors: Naoise Holohan, Maynooth (IE); Mohamed Suliman, Dublin (IE); Ambrish Rawat, Dublin (IE); Stefano Braghin, Dublin (IE)

(21) Appl. No.: 18/419,913

(22) Filed: Jan. 23, 2024

(51) Int. Cl. G06F 7/499

(52) U.S. Cl. CPC G06F 7/49915

(57) ABSTRACT

Secure noise addition in floating-point numbers is provided. It is determined whether digits of a mantissa of a summed floating-point number include a set of trailing zeros at an end of the mantissa of the summed floating-point number. In response to determining that the digits of the mantissa of the summed floating-point number include the set of trailing zeros at the end of the mantissa of the summed floating-point number, the set of trailing zeros at the end of the mantissa of the summed floating-point number is replaced with a set of digits selected from a group of random digits to form an output floating-point number that is free from traces of a sensitive non-integer input value satisfying differential privacy guarantee of data security immune from floating-point attack.

### BACKGROUND

The disclosure relates generally to differential privacy and more specifically to adding noise to data.

Differential privacy is a mathematical framework for ensuring the security of data. Differential privacy guarantees data security by allowing data to be analyzed without revealing sensitive information contained within the data. This is done by making arbitrary changes to the data that do not change the statistics of interest. In other words, differential privacy provides computer scientists and data scientists a way to prevent individual data records from being identified by adding noise to the data in a controlled way while still allowing for the extraction of valuable insights from the data. Essentially, an algorithm that is differentially private injects a predetermined amount of noise into a dataset using, for example, a Gaussian distribution, Laplacian distribution, uniform distribution, or the like to inject the noise. This noise guarantees plausible deniability, and thus protection for the data that is being used.

### SUMMARY

According to one illustrative embodiment, a computer-implemented method for secure noise addition in floating-point numbers is provided. A computer determines whether digits of a mantissa of a summed floating-point number include a set of trailing zeros at an end of the mantissa of the summed floating-point number. In response to the computer determining that the digits of the mantissa of the summed floating-point number include the set of trailing zeros at the end of the mantissa of the summed floating-point number, the computer replaces the set of trailing zeros at the end of the mantissa of the summed floating-point number with a set of digits selected from a group of random digits to form an output floating-point number that is free from traces of a sensitive non-integer input value satisfying differential privacy guarantee of data security immune from floating-point attack. According to other illustrative embodiments, a computer system and computer program product for secure noise addition in floating-point numbers are provided.

### BRIEF DESCRIPTION OF THE DRAWINGS

FIG. 1 is a pictorial representation of a computing environment in which illustrative embodiments may be implemented;

FIG. 2 is a diagram illustrating an example of a secure floating-point number noise addition system in accordance with an illustrative embodiment; and

FIGS. 3A-3B are a flowchart illustrating a process for secure noise addition in floating-point numbers in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

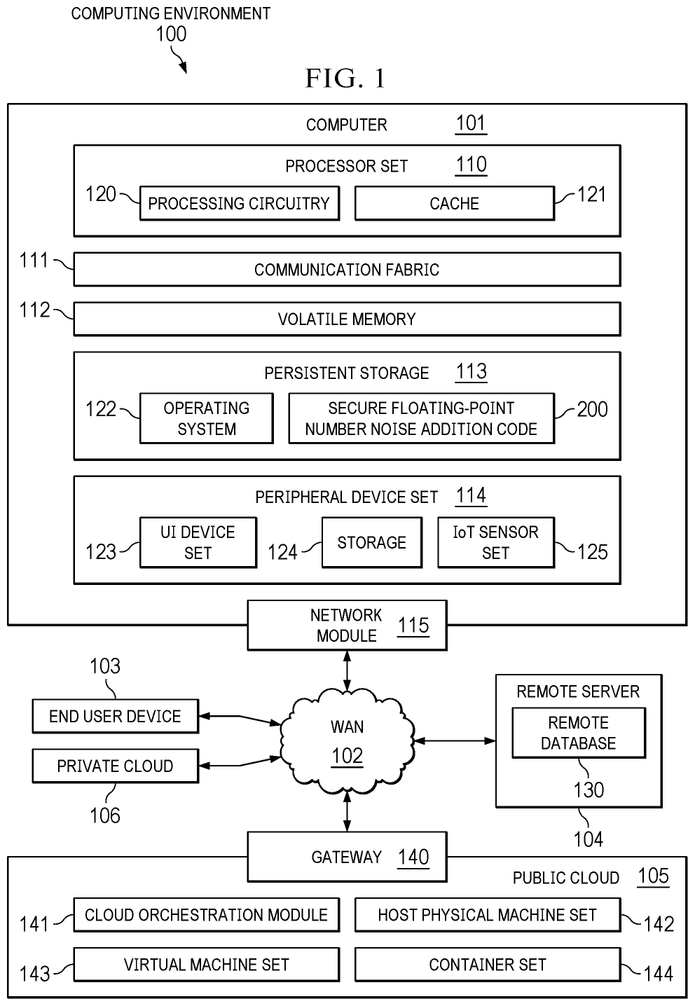

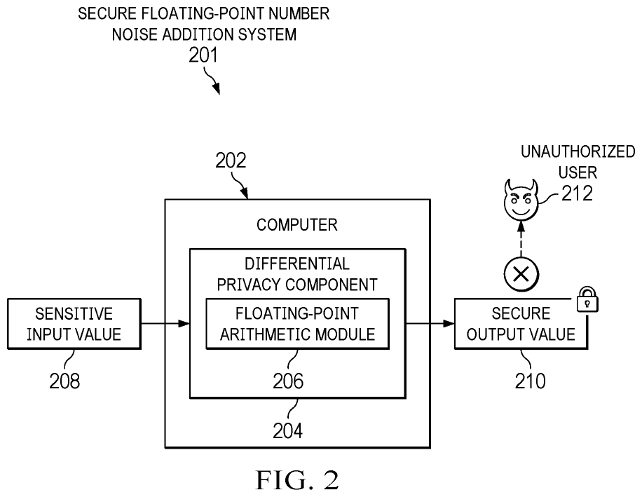

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as secure floating-point number noise addition code 200. For example, secure floating-point number noise addition code 200 adds noise in the form of a random floating-point number to a floating-point number representing a sensitive non-integer input value, while preserving the known precision of the sensitive non-integer input value by taking into account the potential loss of precision caused by the addition of the noise to the floating-point representation of the sensitive non-integer input value. In other words, secure floating-point number noise addition code 200 takes into account input-dependent randomized injection when adding a random floating-point number to a fixed floating-point number. The sensitive non-integer input values represented by the floating-point numbers may be, for example, monetary amounts in bank statements, financial reports, billing statements, spreadsheets, or the like. It should be noted that the sensitive input value can be an integer (e.g., 1.0) or some non-integer type that is represented by a floating-point number.

In addition to secure floating-point number noise addition code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and secure floating-point number noise addition code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in secure floating-point number noise addition code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a data scientist utilizing the secure floating-point number noise addition services provided by computer 101), and may take any of the forms discussed above in connection with computer 101. EUD 103 typically receives helpful and useful data from the operations of computer 101. For example, in a hypothetical case where computer 101 is designed to provide an output of floating-point numbers that are free from traces or hints of sensitive non-integer input values satisfying the differential privacy guarantee of data security immune from floating-point attacks to the end user, this output would typically be communicated from network module 115 of computer 101 through WAN 102 to EUD 103. In this way, EUD 103 can display, or otherwise present, the output to the end user. In some embodiments, EUD 103 may be a client device, such as thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide floating-point numbers that are free from traces or hints of sensitive non-integer input values satisfying the differential privacy guarantee of data security immune from floating-point attacks based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Differential privacy adds random noise to safeguard output values. Computers commonly represent non-integer numbers in a floating-point format. The normalization step in floating-point arithmetic can leak sensitive information corresponding to the output values because the precision loss results in a deterministic number of zeros at the end of the mantissa (also known as the significand) in the floating-point representation of the sensitive information. An unauthorized user can exploit this leakage to obtain the sensitive information. Illustrative embodiments change the trailing zeros at the end of the mantissa with random digits thereby preventing the leakage of the sensitive information, while preserving the differential privacy guarantee of data security.

Differential privacy adds specially-calibrated random noise (i.e., random floating point numbers) to floating-point numbers representing sensitive non-integer input values to protect the sensitive non-integer input values against unwanted inference and exploitation. However, current floating-point arithmetic solutions can leak traces, clues, suggestions, or hints about the sensitive non-integer input values that unauthorized users can exploit breaking the differential privacy guarantee of data security. By intervening in the noise addition operation and changing the lower-order digits of the floating-point number representing the sensitive non-integer input value, illustrative embodiments prevent the leakage and potential exploitation by an unauthorized user.

Illustrative embodiments can apply to any differential privacy solution where noise is added directly to floating-point numbers representing sensitive non-integer input values. Further, illustrative embodiments can apply to any other type of solutions where guarantees are needed when adding noise to floating-point numbers. In other words, illustrative embodiments can have universal applicability across many types of solutions, such as, for example, half-, single-, double-, quad-, and the like precision IEEE 754 floating point standards as well as other non-IEEE standards, which add random noise to floating-point numbers.

Floating-point numbers are the standard representation of non-integer numbers by a computer. Floating-point numbers use a sign, a mantissa or significand, and an exponent to represent a large range of real numbers, with varying granularity, using a finite number of bits. For example, 12.345=12345×10⁻³, where 12345 represents the mantissa, 10 is the base, and −3 is the exponent. The IEEE 754 standard represents a double-precision floating point number (i.e., a double or binary64) using 1 bit for the sign, 11 bits for the exponent, and 52 bits for the mantissa.

When summing (e.g., adding or subtracting) two floating-point numbers, the floating-point arithmetic operation performs the following steps: 1) match exponents by converting the smaller exponent to the larger exponent; 2) perform the arithmetic operation; and 3) renormalize the floating-point number to ensure that a non-zero leading digit exists in the floating-point number. However, precision loss can occur when the arithmetic operation results in a lower exponent number (i.e., when two floating-point numbers are subtracted), which leaves a trace or hint of the original input value. As an illustrative example:

1.0245−0.84521

=1.0245×10⁰−8.4521×10⁻¹

Match exponents→=1.0245×10⁰−0.8452×10⁰

Perform operation→=0.17930×10⁰

Renormalize==1.7930×10⁻¹

It should be noted that all examples herein are given in a decimal format for ease-of-understanding only. Also, it should be noted that this illustrative example uses 5 digits of precision. In this illustrative example, precision loss occurs at 0.8452×100 and 1.7930×10⁻¹. The IEEE 754 standard allows for a guard digit to ensure one fewer digit of precision loss in such cases.

Differential privacy adds noise to a floating-point number representing a sensitive non-integer input value using a selected probability distribution (e.g., Gaussian distribution, Laplacian distribution, uniform distribution, or the like), which is coded into the differential privacy algorithm, to protect the sensitive integer input value from information leakage and potential exploitation by an unauthorized user. However, when floating-point arithmetic operations are performed, information leakage is possible. For example, an unauthorized user can utilize a precision-based attack to exploit the information leakage. Current defenses to precision-based attacks and other types of attacks exploiting floating-point vulnerabilities in differential privacy rely on at least one of the following: 1) discretizing the data to scaled integer values; 2) using complex sampling procedures based on non-standard libraries; and 3) using computationally costly sampling procedures. Illustrative embodiments take into account and address these issues. Additionally, and specific to differential privacy, illustrative embodiments safeguard the operations of floating-point arithmetic to ensure that the differential privacy data security guarantee is maintained.

When summing two floating-point numbers of different signs (i.e., a subtraction operation), loss of precision can occur in the output value, which an unauthorized user can exploit. For example, given an input value of 1.0 with noise added, any output value in the open interval (0, 1.0) is guaranteed to have trailing zero digits at the end of the mantissa. In contrast, given an input value of 0.0 with noise added, the output value in the open interval (0.0, 1.0) is not guaranteed to have trailing zero digits at the end of the mantissa of the floating-point number (although it may still have, by the randomness of the added noise). An unauthorized user can exploit these deterministic contrasts at an arbitrarily low privacy budget to distinguish between different input values. Similar conditions can be given for numbers of arbitrary orders of magnitude. This loss of precision occurs irrespective of any representation error (i.e., error in 0.1+0.2).

Illustrative examples of floating point numbers with 5 digits of precision:

1.0000×10⁰−3.3333×10⁻¹=1.0000×10⁰−0.3333×100=0.6667×10⁰=6.6670×10⁻¹;

1.0000×10⁰−9.2345×10⁻¹=1.0000×10⁰−0.9234×100=0.0766×10⁰=7.6600×10⁻²;

1.0000×10⁰−1.0000×10⁻⁴=1.0000×10⁰−0.0001×10⁰=0.9999×10⁰=9.9990×10⁻¹;

0.0000×10⁰−1.2345×10⁻³=0.0000×10⁻³−1.2345×10⁻³=1.2345×10⁻³.

In these illustrative examples above, loss of precision occurs at 6.6670×10⁻¹, 7.6600×10⁻², and 9.9990×10⁻¹.

The same vulnerability does not exist under floating-point number addition operations (e.g., no loss of precision). For example:

1.0000×10⁰+1.2345×10⁻¹ 32 1.0000×10⁰+0.1234×10⁰=1.1234×100;

1.0000×10⁰+1.0101×10⁵=0.0001×10⁵+1.0101×10⁵=1.0102×10⁵.

When subtracting similar floating-point numbers, the granularity around zero is greatly affected by the input value. As an illustrative example:

1.0000×10⁰−9.9999×10⁻¹=1.0000×10⁰−0.9999×10⁰=0.0001×10⁰=1.0000×10⁻⁴;

1.0000×10⁻¹⁰−9.9999×10⁻¹¹=1.0000×10⁻¹⁰−0.9999×10¹⁰=0.0001×10¹⁰=1.0000×10¹⁴.

In this illustrative example above, the smallest non-zero value that can be realized from 1.0 is 10⁻⁴. Therefore, it is possible to deduce from the second output value (1.0×10⁻¹⁴) that its input value could not have been 1.0, which allows an unauthorized user to distinguish between the two input values. As a result, there is no plausible deniability. However, information leakage is less likely than that of loss of precision.

Illustrative embodiments enable secure addition of noise to floating-point numbers. Illustrative embodiments receive as input a floating-point number representing a sensitive input value. Illustrative embodiments generate a random floating-point number representing a noise value and a group of random digits. Illustrative embodiments add the random floating-point number representing the noise value to the floating-point number representing the sensitive input value. Subsequently, illustrative embodiments return an output value that is a floating-point number satisfying differential privacy, which is immune from floating-point attacks, such as, for example, precision-based attacks.

Illustrative embodiments take into account and address two issues of current floating-point arithmetic solutions. One issue is loss of precision. For example, illustrative embodiments determine the number of trailing digits that are zeros in the floating-point number representing the sensitive non-integer input value. Illustrative embodiments then replace the trailing zero digits with other digits using the generated group of random digits. The randomly generated digits can include non-zero digits and/or zero digits. It could by chance be that illustrative embodiments replace the trailing zeros with zeros again, as the process is random. The other issue is granularity near zero. For example, when an output value is precisely zero (0), illustrative embodiments generate a new output value, which is a new floating-point number, near or close to zero.

Illustrative embodiments generate a summed floating-point number by adding a random floating-point number representing a noise value to a floating-point number representing a sensitive non-integer input value using standard floating-point arithmetic operations. After generating the summed floating-point number by adding the random floating-point number representing the noise value to the floating-point number representing the sensitive non-integer input value, illustrative embodiments determine the number of trailing zero digits at the end of the mantissa of the summed floating-point number. The number of trailing zero digits at the end of the mantissa of the summed floating-point number is the difference between (i) one of a higher exponent of the floating-point number representing the sensitive input value or the random floating point number representing the noise value and (ii) the exponent of the summed floating-point number. As an illustrative example:

1.0000×10⁰−3.3333×10⁻¹=1.0000×10⁰−0.3333×100=0.6667×10⁰=6.6670×10^{−1};

1.0000×10⁰−9.2345×10⁻¹=1.0000×10⁰−0.9234×10⁰=0.0766×10⁰=7.6600×10^{−2}.

Illustrative embodiments replace the trailing zero digits of the summed floating-point number with a set of randomly selected digits. In the second example above, 1.0000×10⁰ is the floating-point number representing the sensitive non-integer input value. The digits 92345 represent the random noise value, which illustrative embodiments scale to the appropriate floating point number in order to be added to the floating-point number representing the sensitive non-integer input value. In the second example, 7.6600×10⁻² represents the summed floating-point number. Illustrative embodiments replace the two trailing zero digits of the mantissa with the randomly selected digits, such as, for example, 8 and 9, which illustrative embodiments scale to the appropriate floating-point number in order to replace the two trailing zero digits. For example:

7.6600×10⁻²+8.9×10⁻⁵=7.6600×10⁻²+0.0089×10⁻²=7.6689×10⁻².

Afterward, illustrative embodiments return an output floating point number of 7.6689×10⁻² to the user instead of 7.6600×10⁻², which an unauthorized user could possibly exploit to obtain information or hints regarding the sensitive non-integer input value.

It is possible for illustrative embodiments to generate a summed floating-point number, which is zero, by summing floating point number representing the noise value and the floating-point number representing the sensitive non-integer input value using standard floating-point arithmetic operations. As an illustrative example:

1.2345×10⁰−1.2345×10⁰=0.0000×10⁰.

When the summed floating-point number is zero, illustrative embodiments generate a new random floating point number in the open space (−1, 1) taking into account the digit or unit in the last place of the floating-point number representing the sensitive non-integer input value. In the illustrative example above, the digit or unit in the last place of the floating-point number (i.e., 5) is at 10⁻⁴. In this example, the new random number is −0.58271 or −5.8271×10⁻¹. Illustrative embodiments scale the new random floating-point number with respect to the unit in the last place of the floating-point number representing the sensitive non-integer input value, such as, for example, (−5.8271×10⁻¹)×10⁻⁴=−5.8271×10⁻⁵. If the output floating-point number is not zero, then illustrative embodiments return the output to the user for analysis. If the output floating-point number is still zero, then illustrative embodiments generate another random floating point number in the open space (−1, 1) taking into account a new unit in the last place of the output floating-point number, which in this example is 10⁻⁹. As a result, all floating-point numbers close to zero (e.g., 1.0000×10⁻⁴, 1.0000×10⁻¹⁴, or the like) are now reachable from any non-integer input value.

Illustrative embodiments are equivalent to a linear interpolation of the cumulative distribution function over very small intervals. The discrepancy between the interpolated cumulative distribution function and the true cumulative distribution function is very small (e.g., on the order of 2⁻¹⁰⁴≈10⁻³², when randomly changing two digits with the differential privacy parameter (6) being equal to 1). Using Rolle's Theorem and the Dvoretzky-Kiefer-Wolfowitz inequality, at least 10⁶³ draws from the distribution would be needed to distinguish the interpolated cumulative distribution function from the true cumulative distribution function with 95% confidence, which would take orders of magnitude longer than the age of the universe to sample. As a result, because this is sufficiently close to the original distribution and is computationally infeasible to perceive, illustrative embodiments satisfy the differential privacy guarantee of data security.

Thus, illustrative embodiments provide one or more technical solutions that overcome a technical problem with current floating-point arithmetic solutions inability to prevent information leakage and loss of precision in floating-point numbers when performing floating-point arithmetic operations. As a result, these one or more technical solutions provide a technical effect and practical application in the field of differential privacy.

With reference now to FIG. 2, a diagram illustrating an example of a secure floating-point number noise addition system is depicted in accordance with an illustrative embodiment. Secure floating-point number noise addition system 201 may be implemented in a computing environment, such as computing environment 100 in FIG. 1. Secure floating-point number noise addition system 201 is a system of hardware and software components for outputting floating-point numbers that are free from traces or hints of sensitive non-integer input values satisfying the differential privacy guarantee of data security immune from floating-point attacks by unauthorized users.

In this example, secure floating-point number noise addition system 201 includes computer 202. Computer 202 may be, for example, computer 101 in FIG. 1. Computer 202 includes differential privacy component 204. Computer 202 utilizes differential privacy component 204 to provide floating-point numbers that are free from traces or hints of sensitive non-integer input values satisfying the differential privacy guarantee of data security. Differential privacy component 204 includes floating-point arithmetic module 206. Floating-point arithmetic module 206 can be implemented by, for example, secure floating-point number noise addition code 200 in FIG. 1. Differential privacy component 204 utilizes floating-point arithmetic module 206 to perform arithmetic summing operations on floating-point numbers while preserving the known precision of sensitive non-integer input values by taking into account the potential loss of precision caused by the addition of random floating-point numbers representing noise values to floating-point numbers representing sensitive non-integer input values. Floating-point arithmetic module 206 receives sensitive non-integer input value 208 and returns secure floating-point output value 210, which is immune from floating-point attacks by unauthorized user 212.

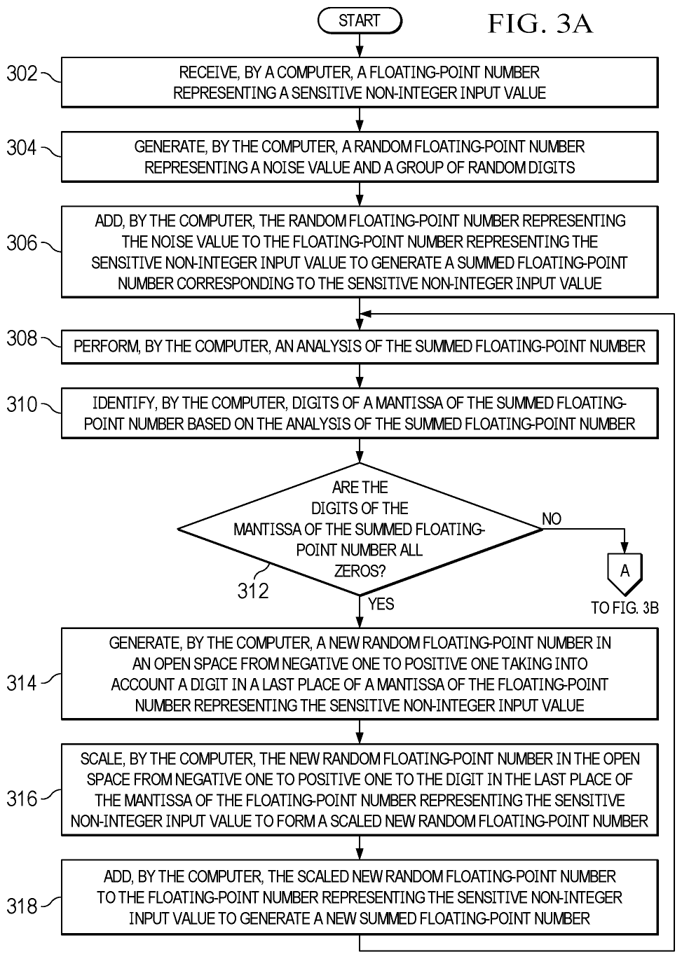

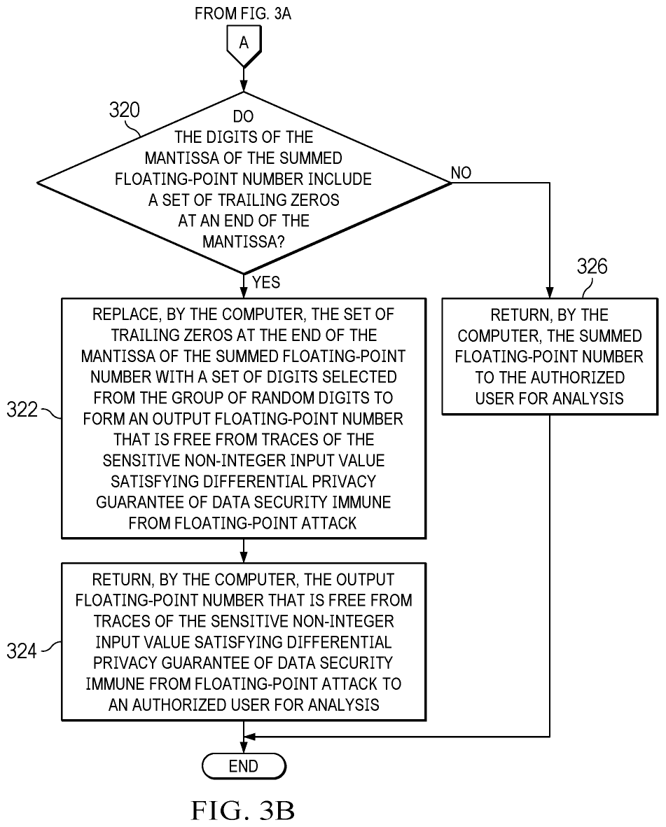

With reference now to FIGS. 3A-3B, a flowchart illustrating a process for secure noise addition in floating-point numbers is shown in accordance with an illustrative embodiment. The process shown in FIGS. 3A-3B may be implemented in a computer, such as, for example, computer 101 in FIG. 1 or computer 202 in FIG. 2. For example, the process shown in FIGS. 3A-3B may be implemented by secure floating-point number noise addition code 200 in FIG. 1 or floating-point arithmetic module 206 in FIG. 2.

The process begins when the computer receives a floating-point number representing a sensitive non-integer input value (step 302). In response to receiving the floating-point number representing the sensitive non-integer input value, the computer generates a random floating-point number representing a noise value and a group of random digits (step 304). It should be noted that the group of random digits can include at least one of non-zero digits and zero digits. The computer adds the random floating-point number representing the noise value to the floating-point number representing the sensitive non-integer input value to generate a summed floating-point number corresponding to the sensitive non-integer input value (step 306).

The computer performs an analysis of the summed floating-point number (step 308). The computer identifies digits of a mantissa of the summed floating-point number based on the analysis of the summed floating-point number (step 310).

The computer makes a determination as to whether the digits of the mantissa of the summed floating-point number are all zeros (step 312). If the computer determines that the digits of the mantissa of the summed floating-point number are all zeros, yes output of step 312, then the computer generates a new random floating-point number in an open space from negative one to positive one taking into account a digit in a last place of a mantissa of the floating-point number representing the sensitive non-integer input value (step 314). In addition, the computer scales the new random floating-point number in the open space from negative one to positive one to the digit in the last place of the mantissa of the floating-point number representing the sensitive non-integer input value to form a scaled new random floating-point number (step 316). The computer adds the scaled new random floating-point number to the floating-point number representing the sensitive non-integer input value to generate a new summed floating-point number (step 318). Thereafter, the process returns to step 308 where the computer performs an analysis of the new summed floating-point number.

Returning again to step 312, if the computer determines that the digits of the mantissa of the summed floating-point number are not all zeros, no output of step 312, then the computer makes a determination as to whether the digits of the mantissa of the summed floating-point number include a set of trailing zeros at an end of the mantissa of the summed floating-point number (step 320). If the computer determines that the digits of the mantissa of the summed floating-point number include a set of trailing zeros at an end of the mantissa of the summed floating-point number, yes output of step 320, then the computer replaces the set of trailing zeros at the end of the mantissa of the summed floating-point number with a set of digits selected from the group of random digits to form an output floating-point number that is free from traces of the sensitive non-integer input value satisfying differential privacy guarantee of data security immune from floating-point attack (step 322). Afterward, the computer returns the output floating-point number that is free from traces of the sensitive non-integer input value satisfying differential privacy guarantee of data security immune from floating-point attack to an authorized user for analysis (step 324). Thereafter, the process terminates.

Returning again to step 320, if the computer determines that the digits of the mantissa of the summed floating-point number do not include a set of trailing zeros at an end of the mantissa of the summed floating-point number, no output of step 320, then the computer returns the summed floating-point number to the authorized user for analysis (step 326). Thereafter, the process terminates.

Thus, illustrative embodiments of the present disclosure provide a computer-implemented method, computer system, and computer program product for providing secure noise addition in floating-point numbers. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for secure noise addition in floating-point numbers, the computer-implemented method comprising:
determining, by a computer, whether digits of a mantissa of a summed floating-point number include a set of trailing zeros at an end of the mantissa of the summed floating-point number; and
responsive to the computer determining that the digits of the mantissa of the summed floating-point number include the set of trailing zeros at the end of the mantissa of the summed floating-point number, replacing, by the computer, the set of trailing zeros at the end of the mantissa of the summed floating-point number with a set of digits selected from a group of random digits to form an output floating-point number that is free from traces of a sensitive non-integer input value satisfying differential privacy guarantee of data security immune from floating-point attack.

2. The computer-implemented method of claim 1, further comprising:
returning, by the computer, the output floating-point number that is free from traces of the sensitive non-integer input value satisfying differential privacy guarantee of data security immune from floating-point attack.

3. The computer-implemented method of claim 1, further comprising:
receiving, by the computer, the floating-point number representing the sensitive non-integer input value; and
generating, by the computer, a random floating-point number representing a noise value and the group of random digits in response to receiving the floating-point number representing the sensitive non-integer input value.

4. The computer-implemented method of claim 1, further comprising:
adding, by the computer, a random floating-point number representing a noise value to the floating-point number representing the sensitive non-integer input value to generate the summed floating-point number corresponding to the sensitive non-integer input value; and
performing, by the computer, an analysis of the summed floating-point number.

5. The computer-implemented method of claim 1, further comprising:
identifying, by the computer, the digits of the mantissa of the summed floating-point number based on an analysis of the summed floating-point number; and
determining, by the computer, whether the digits of the mantissa of the summed floating-point number are all zeros.

6. The computer-implemented method of claim 5, further comprising:
responsive to the computer determining that the digits of the mantissa of the summed floating-point number are all zeros, generating, by the computer, a new random floating-point number in an open space from negative one to positive one taking into account a digit in a last place of a mantissa of the floating-point number representing the sensitive non-integer input value;
scaling, by the computer, the new random floating-point number in the open space from negative one to positive one to the digit in the last place of the mantissa of the floating-point number representing the sensitive non-integer input value to form a scaled new random floating-point number; and
adding, by the computer, the scaled new random floating-point number to the floating-point number representing the sensitive non-integer input value to generate a new summed floating-point number.

7. The computer-implemented method of claim 5, further comprising:
responsive to the computer determining that the digits of the mantissa of the summed floating-point number are not all zeros, determining, by the computer, whether the digits of the mantissa of the summed floating-point number include the set of trailing zeros at the end of the mantissa of the summed floating-point number.

8. The computer-implemented method of claim 1, wherein the number of trailing zero digits at the end of the mantissa of the summed floating-point number is a difference between one of a higher exponent of the floating-point number representing the sensitive non-integer input value or the random floating point number representing a noise value and an exponent of the summed floating-point number.

9. A computer system for secure noise addition in floating-point numbers, the computer system comprising:
a communication fabric;
a set of computer-readable storage media connected to the communication fabric, wherein the set of computer-readable storage media collectively stores program instructions; and
a set of processors connected to the communication fabric, wherein the set of processors executes the program instructions to:
determine whether digits of a mantissa of a summed floating-point number include a set of trailing zeros at an end of the mantissa of the summed floating-point number; and
replace the set of trailing zeros at the end of the mantissa of the summed floating-point number with a set of digits selected from a group of random digits to form an output floating-point number that is free from traces of a sensitive non-integer input value satisfying differential privacy guarantee of data security immune from floating-point attack in response to determining that the digits of the mantissa of the summed floating-point number include the set of trailing zeros at the end of the mantissa of the summed floating-point number.

10. The computer system of claim 9, wherein the set of processors further executes the program instructions to:
return the output floating-point number that is free from traces of the sensitive non-integer input value satisfying differential privacy guarantee of data security immune from floating-point attack.

11. The computer system of claim 9, wherein the set of processors further executes the program instructions to:
receive the floating-point number representing the sensitive non-integer input value; and
generate a random floating-point number representing a noise value and the group of random digits in response to receiving the floating-point number representing the sensitive non-integer input value.

12. The computer system of claim 9, wherein the set of processors further executes the program instructions to:
add a random floating-point number representing a noise value to the floating-point number representing the sensitive non-integer input value to generate the summed floating-point number corresponding to the sensitive non-integer input value; and
perform an analysis of the summed floating-point number.

13. The computer system of claim 9, wherein the set of processors further executes the program instructions to:
identify the digits of the mantissa of the summed floating-point number based on an analysis of the summed floating-point number; and
determine whether the digits of the mantissa of the summed floating-point number are all zeros.

14. The computer system of claim 13, wherein the set of processors further executes the program instructions to:
generate a new random floating-point number in an open space from negative one to positive one taking into account a digit in a last place of a mantissa of the floating-point number representing the sensitive non-integer input value in response to determining that the digits of the mantissa of the summed floating-point number are all zeros;
scale the new random floating-point number in the open space from negative one to positive one to the digit in the last place of the mantissa of the floating-point number representing the sensitive non-integer input value to form a scaled new random floating-point number; and
add the scaled new random floating-point number to the floating-point number representing the sensitive non-integer input value to generate a new summed floating-point number.

15. A computer program product for secure noise addition in floating-point numbers, the computer program product comprising a set of computer-readable storage media having program instructions collectively stored therein, the program instructions executable by a computer to cause the computer to:
determine whether digits of a mantissa of a summed floating-point number include a set of trailing zeros at an end of the mantissa of the summed floating-point number; and
replace the set of trailing zeros at the end of the mantissa of the summed floating-point number with a set of digits selected from a group of random digits to form an output floating-point number that is free from traces of a sensitive non-integer input value satisfying differential privacy guarantee of data security immune from floating-point attack in response to determining that the digits of the mantissa of the summed floating-point number include the set of trailing zeros at the end of the mantissa of the summed floating-point number.

16. The computer program product of claim 15, wherein the program instructions further cause the computer to:
return the output floating-point number that is free from traces of the sensitive non-integer input value satisfying differential privacy guarantee of data security immune from floating-point attack.

17. The computer program product of claim 15, wherein the program instructions further cause the computer to:
receive the floating-point number representing the sensitive non-integer input value; and
generate a random floating-point number representing a noise value and the group of random digits in response to receiving the floating-point number representing the sensitive non-integer input value.

18. The computer program product of claim 15, wherein the program instructions further cause the computer to:
add a random floating-point number representing a noise value to the floating-point number representing the sensitive non-integer input value to generate the summed floating-point number corresponding to the sensitive non-integer input value; and
perform an analysis of the summed floating-point number.

19. The computer program product of claim 15, wherein the program instructions further cause the computer to:
identify the digits of the mantissa of the summed floating-point number based on an analysis of the summed floating-point number; and
determine whether the digits of the mantissa of the summed floating-point number are all zeros.

20. The computer program product of claim 19, wherein the program instructions further cause the computer to:
generate a new random floating-point number in an open space from negative one to positive one taking into account a digit in a last place of a mantissa of the floating-point number representing the sensitive non-integer input value in response to determining that the digits of the mantissa of the summed floating-point number are all zeros;
scale the new random floating-point number in the open space from negative one to positive one to the digit in the last place of the mantissa of the floating-point number representing the sensitive non-integer input value to form a scaled new random floating-point number; and
add the scaled new random floating-point number to the floating-point number representing the sensitive non-integer input value to generate a new summed floating-point number.
